(19) United States
(12) Patent Application Publication
(10) Pub. No.: US 2020/0349839 A1
(43) Pub. Date: Nov. 5, 2020

(54) IMAGE DATA INTEGRATOR FOR ADDRESSING CONGESTION

(71) Applicants: Alain Elie Kaloyeros, Slingerlands, NY (US); Michael F. Hoffman, Loundonville, NY (US)

(72) Inventors: Alain Elie Kaloyeros, Slingerlands, NY (US); Michael F. Hoffman, Loundonville, NY (US)

(21) Appl. No.: 16/930,425

(22) Filed: Jul. 16, 2020

Related U.S. Application Data
(63) Continuation of application No. 15/941,495, filed on Mar. 30, 2018.
(60) Provisional application No. 62/479,597, filed on Mar. 31, 2017.

(51) Int. Cl. G08G 1/14; B64C 39/02; G06K 9/00; G08G 1/065; G08G 1/04; G08G 1/01

(52) U.S. Cl. CPC G08G 1/144; B64C 2201/123; G06K 9/00771; G06K 9/00651; G06K 9/00785; G08G 1/065; G08G 1/146; G08G 1/04; G08G 1/012; G08G 1/0133; G08G 1/147; G08G 1/148; G08G 1/0141; B64C 2201/127; G06K 2209/23; G06K 2209/15; B64C 39/024

(57) ABSTRACT

A system, method and program product for that: receives image data from at least one provider such as a drone, on-board vision system, fixed camera, satellite, wearable, smart phone, etc.; processes the image data to identify congestion-based information such as parking spot availability, standby location information, traffic flow information, and line waiting time information; and outputs the information to devices and applications, such as user apps, vehicle fleets, event operators, etc.

### TECHNICAL FIELD

The subject matter of this invention relates to the collection and integration of image data for use in applications that alleviate congestions, such as parking location services, traffic flow, and waiting in lines, and more particularly to integration of image data from disparate sources including drones and on-board systems to assist in alleviating congestion.

### BACKGROUND

As congestion in our everyday lives, including on our roads and in our cities, continues to increase, more and more time and resources are wasted, e.g., due to traffic jams, searching for parking spots, waiting in lines, etc. For example, in large cities, it is not unusual for a driver to circle an area numerous times hoping to find a parking spot. Similarly, it is also not unusual for a patron at an event to wait in a long line to buy a ticket or enter a facility, despite the fact that a shorter line may exist. While technology has helped, e.g., with navigation systems and the like, people must still too often deal with congestion on a daily basis.

### SUMMARY

With the integration of video technology into everyday devices, numerous forms of image data are continuously being generated and are readily available at reasonably low costs. Accordingly, various systems for exploiting the image data are contemplated to alleviate congestion. Aspects of the disclosure provide systems that process various types of image data to address congestion, including locating parking spots, managing real-world queues (e.g., waiting in lines, etc.), managing traffic flow, etc. Image data may come from disparate sources such as drones, on-board cameras, vehicle navigation systems, wearables, smart devices, fixed cameras, etc., and may be integrated for use in third party applications that address congestion issues.

Systems and methods are disclosed that: receive image data from at least one provider such as a drone, on-board vision system, fixed camera, satellite, wearable, smart phone, etc.; process the image data to provide congestion-based information such as parking spot availability, standby location information, traffic flow information, and line waiting time information; and output the information to devices and applications, such as user apps, vehicle fleets, event operators, etc.

In a first aspect, the invention provides a video processing platform, comprising: an input interface for receiving image data items from a plurality of disparate providers; an image data integrator that analyzes image data items from the plurality of disparate providers to generate vehicle congestion information including parking spot availability and traffic flow information, wherein the analyzing includes correlating time and position data to identify related image data items received from disparate providers; and an output interface for outputting the vehicle congestion information to subscribing consumer applications.

In a second aspect, the invention provides a method of video processing, comprising: receiving image data items from a plurality of disparate providers; analyzing image data items from the plurality of disparate providers to generate vehicle congestion information including parking spot availability, wherein the analyzing includes correlating time and position data to identify related image data items received from disparate providers; and outputting the vehicle congestion information to subscribing consumer applications.

In a third aspect, the invention provides a program product stored on a non-transitory computer readable storage medium, which when executed by a computing system, comprises: program code for receiving image data items from a plurality of disparate providers; program code for analyzing image data items from the plurality of disparate providers to generate vehicle congestion information including parking spot availability and traffic flow information, wherein the analyzing includes correlating time and position data to identify related image data items received from disparate providers; and program code for outputting the vehicle congestion information to subscribing consumer applications.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a drone-based parking space locator according to embodiments.

FIG. 2 shows a drone deployment interface according to embodiments.

FIG. 3 shows a drone deployment system according to embodiments.

FIG. 4 shows a system for utilizing on-board vision systems according to embodiments.

FIG. 5 shows a system for providing standby locations to fleets according to embodiments.

FIG. 6 shows an image information processing platform according to embodiments.

FIG. 7 shows a mountable video collection device according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

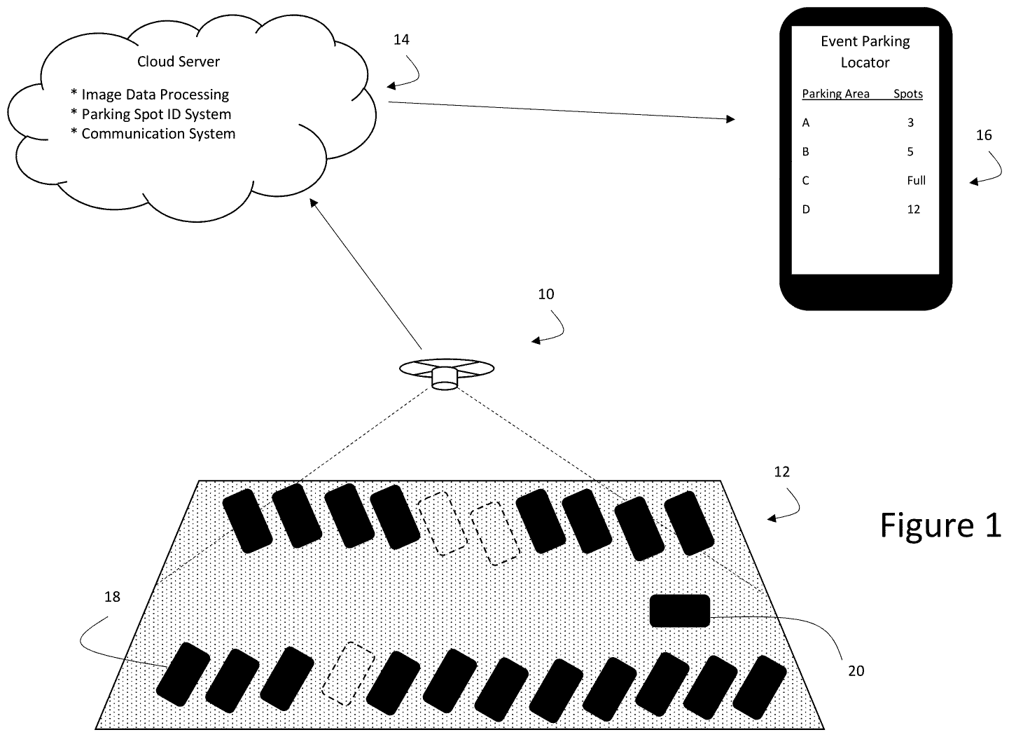

Referring now to the drawings, FIG. 1 depicts a drone-based image processing system for locating parking spots. In the depicted example, a drone 10 is deployed above a parking area 12, collects image data (e.g., video), and transmits the video to a server 14, such as a cloud server. The cloud server processes the image data to identify available parking spots in real-time with a parking spot ID system. Parking spot ID system may utilize any technology, e.g., image processing, artificial intelligence, logic, etc., to determine available spaces in a parking lot, on a street, etc.

In the example shown, the black rectangles 18 indicate parked cars while the dashed rectangles 20 indicate three available spots. In the collected image, there is also an auto 20 entering the lot, which is likely to park in one of the available spots. Accordingly, parking spot ID system may deduce that there are two available spots in the parking area 12. The resulting parking area information can then be communicated via a communication system in real time to an application, such as a smart phone app 16 that shows end user parking availability.

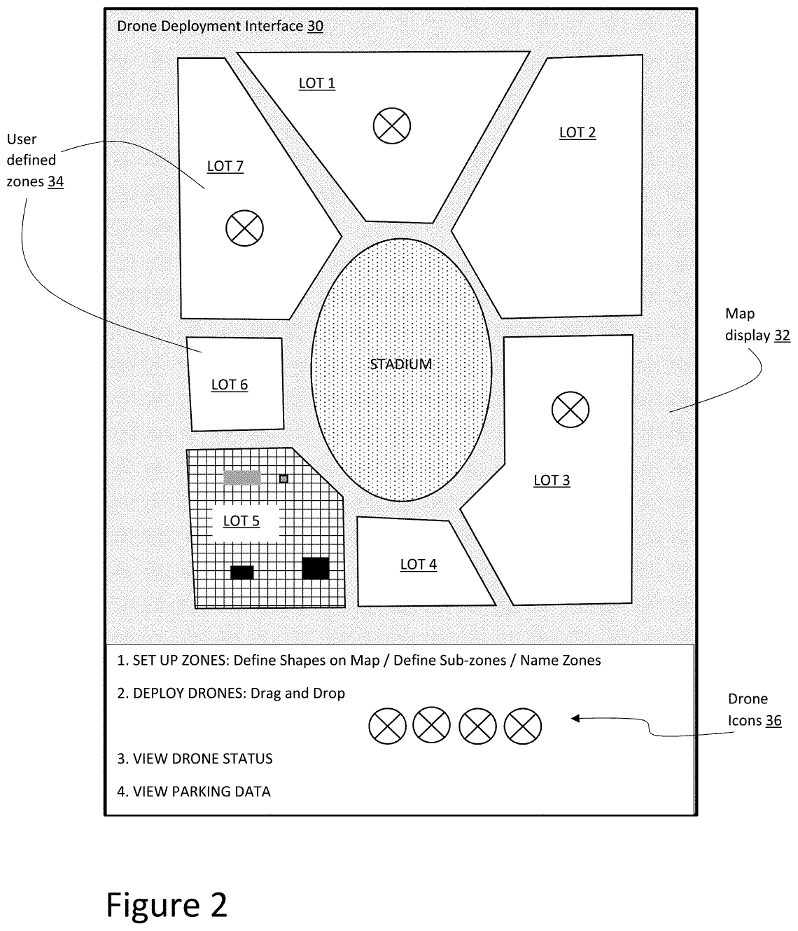

FIG. 2 depicts a drone deployment interface 30 that is implemented as a graphical user interface. The interface 30 includes a map display 32, such as a Google Maps interface, that shows an area over which drones are to be deployed. User defined zones 34 are overlaid onto the map display 32, e.g., using common editing tool or touch screen actions. Once the user defined zones 34 are created, the operator can drag drone icons 36 on to the different zones 24 to cause drones to be deployed over the defined zones. The collected image data can then be used to, e.g., managing parking, traffic flow, etc.

In this embodiment, each zone 34 may comprise a parking lot section around a stadium. Accordingly, when an event at the stadium is beginning, the operator can deploy drones using the interface 30 to collect image data to, e.g., manage traffic flow, parking, and security. Each zone 34 may be further segmented into sub-zones (e.g., small squares in Lot 5) and empty (white), partially filled (gray), or full subzones (black) can be displayed.

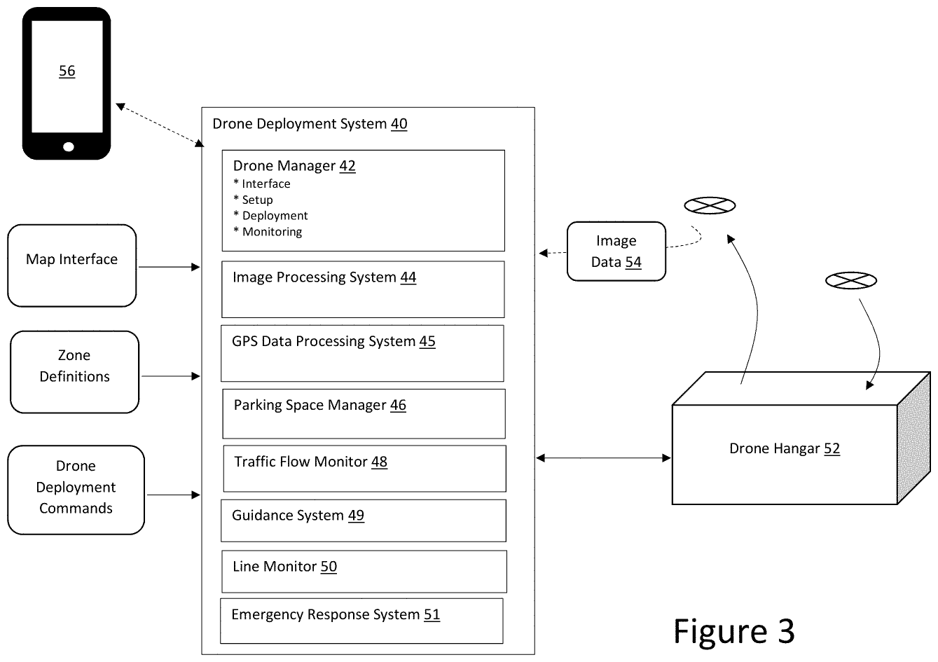

FIG. 3 depicts a drone deployment system 40 for deploying drones, e.g., using the interface 30 of FIG. 2. Drone deployment system 40 generally includes a drone manager 42 for managing the deployment and position of drones, e.g., from a drone hangar 52. Drone manager 42 implements the systems for setting up zones to monitor, deployment of the drones, and monitoring their positions and status. Drone manager 42 may receive as input a map interface, zone definitions and drone deployment commands from a third party service, operator, or other system.

Image processing system 44 receives image data 54 from the deployed drones and processes the data using any known image processing technique to provide information, about e.g., parking space availability for a parking space manager 46, traffic for a traffic flow manager 48, line information for a line manager 50, and emergency response information for an emergency response system 51. The resulting information can thereafter be formatted, further processed and pushed out to end-user apps 56.

In addition, a GPS data processing system 45 may be provided to collect location information of the drones, the user's automobile, and/or a smartphone. GPS information may be utilized to evaluate traffic flow (similar to Google Maps or WAZE) to assist traffic flow monitor 48.

A guidance system 49 may be provided to calculate one or more “pathways” to a parking location for a driver or a less congested line, entry, walkway, etc., option for a pedestrian. In the case of an autonomous vehicle or vehicle equipped with a navigation system, the pathway could be downloaded to the vehicle for guidance. The pathway calculation may take into account traffic flow, shortest distance, shortest time, probability of success, etc.

In one illustrative embodiment, a primary drone would release a “mini-drone” to “pair” with a vehicle and physically guide the user to a target location. The pairing may be implemented with any wireless technology such as blue tooth and may be implemented to automatically control the vehicle or simply provide guidance instructions.

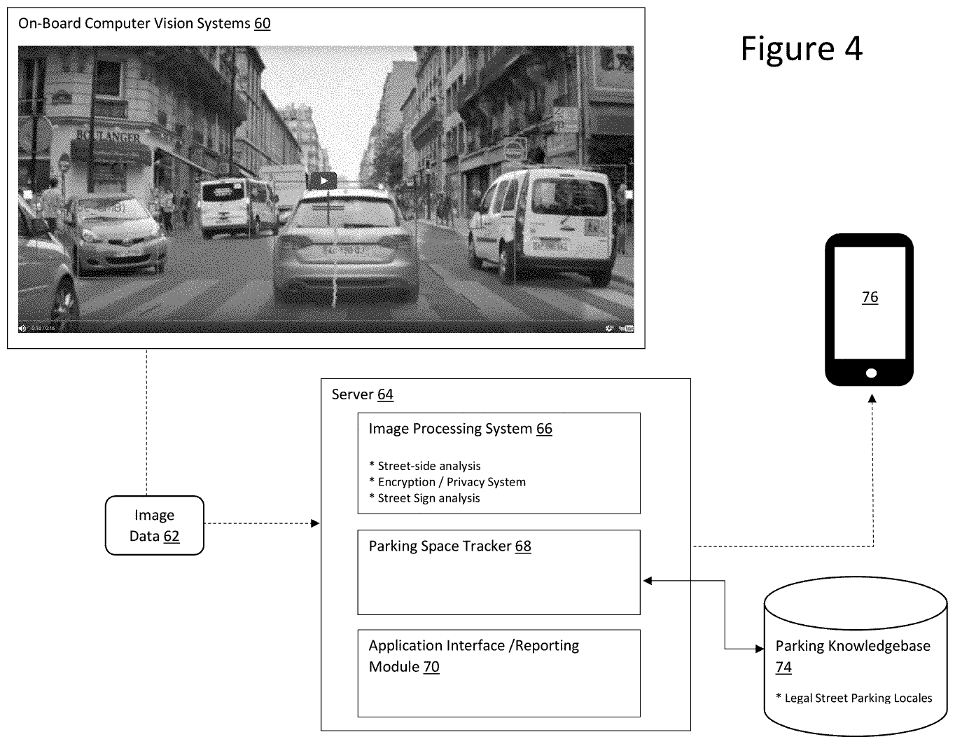

FIG. 4 depicts a further embodiment that collects image data 62 from on-board computer vision systems 60 (e.g., built-in systems, dash cams, smart devices, etc.). On-board computer vision systems 60 collect and process image data from moving vehicles. Such image data 62 is collected from self-driving operations of autonomous, semi-autonomous vehicles, and driver-based vehicles equipped with video based devices that, e.g., provide on-board safety operations, incident capture, social media content, navigation, etc. The present embodiment collects the image data from participating or linked-up vehicles/users and feeds the image data 62 to a server 64. An image processing system 66 processes the image data 62 to evaluate and identify, e.g., potential parking spaces on the side of a street, where traffic bottlenecks exist, emergency vehicles, incidents, etc. The image analysis may also include detecting and reading street signs using content recognition to determine whether a space is a legal parking space. Image data may be collected from a large set of vehicles and correlated together based on time and location to provide a continuous feed of information over a large geography. In one approach, crowd-source image data may be collected from smartphones, dash cams, etc., e.g., attached to dashboards in non-autonomous vehicles, wearables, etc.

In addition, a parking knowledgebase 74 may be utilized to essentially map out locations in a city where legal parking locales exist. The image data 62 can be processed and compared with the knowledgebase 74 to identify available spots using a parking space tracker 68. The parking space tracker 68 may also track how long cars have been parked in time-limited spots, etc., to predict availability and gage turnover rates. An application interface/reporting module can then communicate the information to an application 76, e.g., running on a smart device.

In this embodiment, and encryption and/or privacy system may be employed to keep information private, such as scanned license plates, location information, etc.

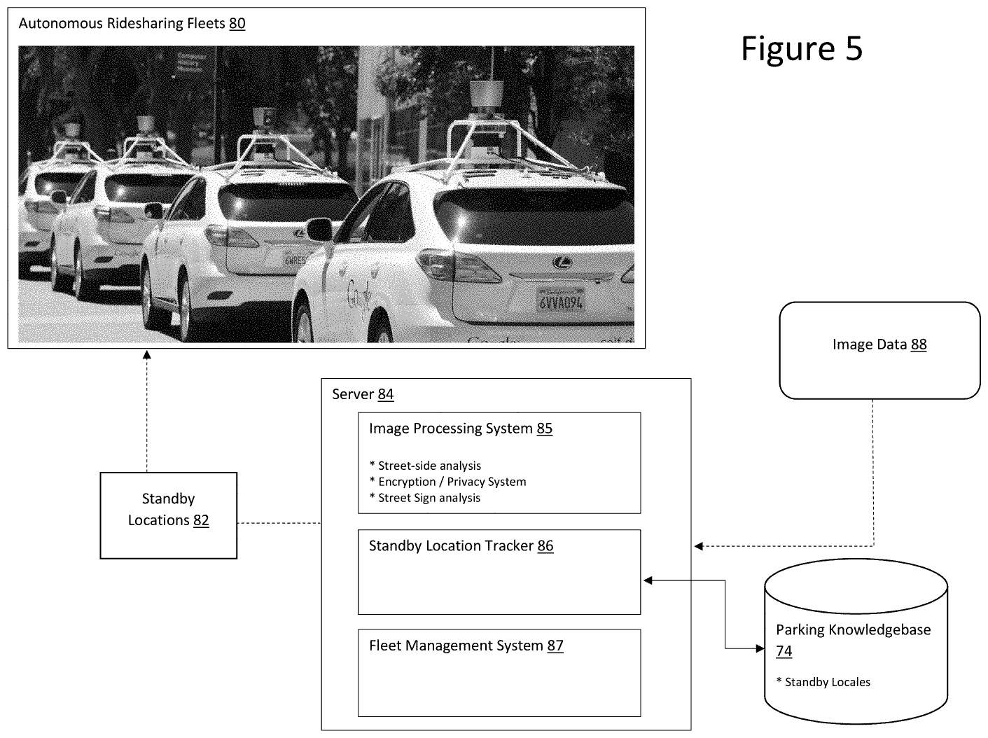

FIG. 5 depicts an embodiment that may be deployed to assist autonomous ride sharing fleets 80 and the like that do not necessarily need permanent parking locations, but require places to stop and wait (i.e., standby) until a next ride request is dispatched. For instance, an autonomous vehicle could temporarily stop and wait at a “standby location 82” such as a loading zone, a bus-stop, a legitimate parking spot, 15 minute parking, etc., while in a standby mode.

Similarly, delivery trucks and the like could be directed to the nearest standby location 82 when making a delivery that could accommodate their vehicle while minimizing the impact on traffic.

Standby locations 82 are generated by a server 84 that inputs image data 88 (from any available source) and processes the images with image processing system 85. A standby location tracker 86 would track all available standby locations 82, and communicate the information to the autonomous ridesharing fleet 80 (or other applications/vehicles). A parking knowledgebase 74 again may be used to map all available standby locales in a city or the like. In addition, a fleet management system 87 may be integrated to manage various aspects of the fleet 80.

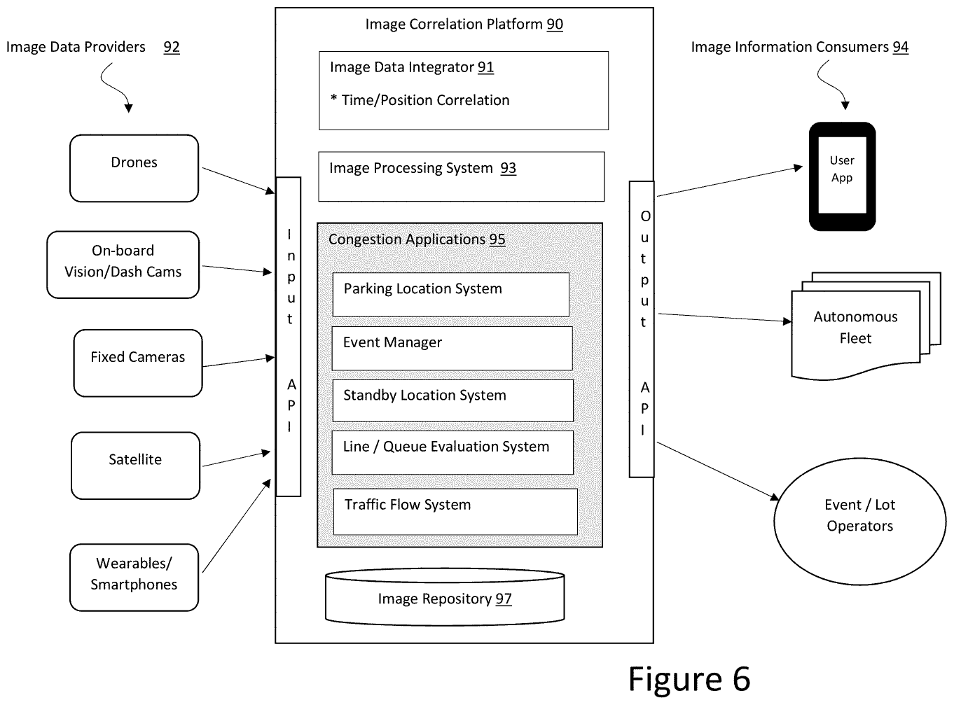

FIG. 6 depicts an image correlation platform 90 that provides a technology agnostic solution that receives image data items (e.g., video files, streaming video, images, etc.) from one or more image data providers 92 and outputs image information to consumer systems 94. Image data items may be received from any number of common or disparate providers 92, such as drones, on-board vision systems, fixed cameras, dash cams, satellites, wearables, immersive technologies, smartphones, etc. The image data items may be streamed or uploaded into the platform 92 via an input API using any type or combination of information exchange protocols, e.g., client server, peer to peer, broad band, wifi, cellular, blue tooth, etc. Image information in turn may be outputted to consumer systems 94 (e.g., user apps, autonomous fleets, event/lot operators, content consumers, etc.) via an output API. In this manner, providers 92 and consumers 94 can essentially plug and play into the platform with little integration overhead. In one illustrative embodiments, providers 92 can “provide, exchange, sell, etc.” their image data to the platform 90 on the front end, and consumers can “view, consume, purchase, etc.,” image information on the back-end. In this embodiment, image data items, which may include actual image data and/or metadata, etc., is stored in image repository 97.

The image correlation platform 90 generally includes an image data integrator 91 that analyzes all of the inputted image data items from the various sources, correlates and cross references the data from different sources (e.g., based on time and location) to identify related items. For example, if two providers (e.g., a drone and a dash cam) captured video of a common location during a common time period, the two items would be correlated as related image data items. By identifying related image data items, a more robust set of image information can be generated.

Correlation platform also include an image processing system 93 that for example analyzes image data to, e.g., perform content recognition (e.g., identification of parking spots, traffic, accidents, emergency vehicles, parking signs, etc.), data analysis (e.g., traffic flow, weather, etc.), etc.

Image correlation platform 90 may also include one or more internal applications that generate specific types of image-based information to information consumers 94 based on collected image data (date, time, location, video, metadata, etc.), correlation information from the image data integrator 91 and image processing results (e.g., content recognition, etc.). For example, internal applications may include congestion applications 95 that determines vehicle congestion, such as: a parking space location system to track and locate parking spots, an event manager for managing parking and traffic at events such as large concerts and sporting events, a standby location system that identifies and tracks standby parking locations for autonomous vehicles and the like, a line/queue evaluation system that determines line length and wait times for people waiting in lines, e.g., at events, a traffic flow system that identifies and monitor traffic congestion, etc.

Other types of internal applications may comprise entertainment applications, incident/evidence applications, etc. The information generated by internal applications can be outputted to information consumers 94 via an output API, and include video feeds, analysis, raw data enhanced content, entertainment, etc. Once generated, information consumers 94 can use the image information for any purpose, e.g., parking and other user apps, to manage autonomous fleets, for event/lot operators, content provisioning, social media, entertainment, evidence, etc.

Furthermore, it is noted that other types of information (other than image data) may be collected and utilized in the any of the described systems. Such other types of data may include navigation/location/speed information collected from vehicles and people (from smart devices, navigation systems, etc.); user provided information (e.g., a user may notify the system when they leave a parking spot); infrared data, heat, sonar data, radar data, etc.; physiological data from users (heartrate information reflecting user frustration), etc.

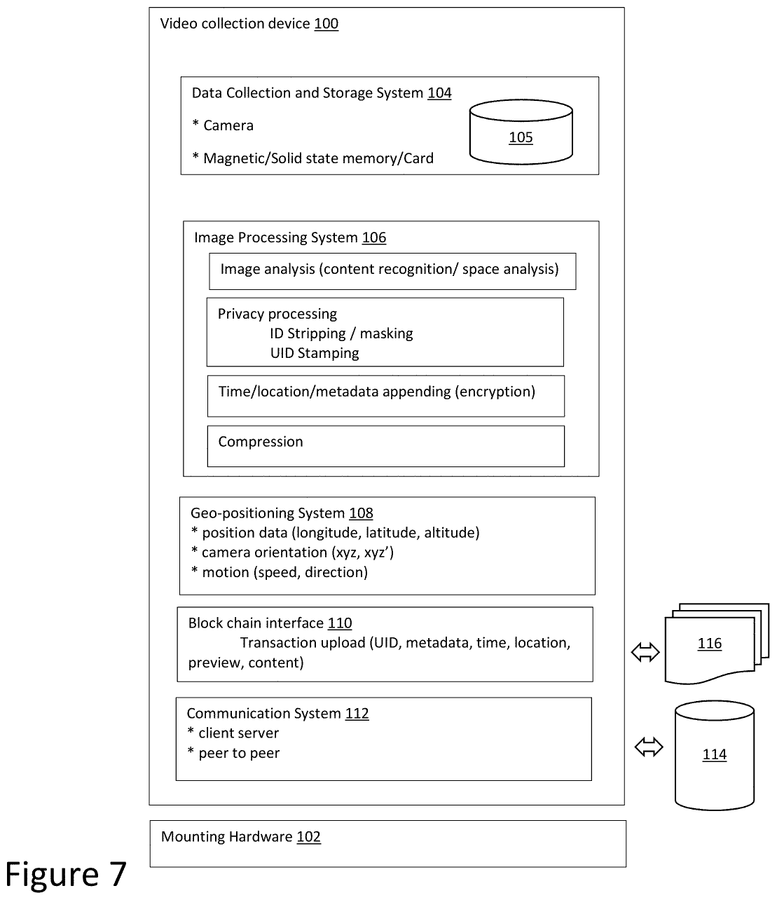

FIG. 7 depicts a video collection device 100 adapted to capture and process image data. In one embodiment, the video collection device 100 is, e.g., mountable to a vehicle dashboard (e.g., a dashcam, backup camera, etc.), to a person, to a piece of sporting equipment, to a drone, to a selfie stick, to a fixed object, etc. Further, the mountable video collection device 100 may be incorporated in a smart device such as a smartphone, laptop, tablet, IoT device, doorbell, security system, etc. In one embodiment video collection device 100 includes mounting hardware 102 for mounting the device 100, e.g., to a dashboard, rear view mirror, bumper, bicycle, person, etc.

Video collection device 100 generally includes: (1) a data collection and storage system 104 having a camera for capturing image data and a magnetic or solid state memory, card, etc., for locally storing image data; (2) an image processing system 106 that for example may provide image analysis, privacy processing, compression, and time/location stamping; (3) a geo-positioning system 108 that determines position, orientation and motion data of the camera in 2D or 3D space; (4) a block chain interface 110 that stores transaction information about captured video, e.g., where, when, who, what recorded, metadata, preview, actual video content, etc.; and (5) a communication system 112 for loading image information to a remote repository 114, e.g., a central server, a cloud system, a distributed storage platform, etc.

In operation, image data is collected and stored in local memory 105. Next, some image processing may be done locally by image processing service 106. For example, the image data may be analyzed to identify objects, e.g., cars parked in on-street parking, available parking spaces, signal-lights, police cars, brake lights, etc. Additionally, the image data may be processed for privacy, e.g., license plates/faces may be masked, identifying information may be stripped from a video, ownership information may be removed, etc. A unique identifier (UID) may be stamped onto the video and metadata such as objects detected, time, location, geo-position data, owner, etc., may also be appended with the video, potentially as encrypted data.

The UID and metadata may be stored in a distributed ledger such as a block chain 116, where it can be later referenced/accessed based on the terms and policies agreed to by the parties involved. The information may be stored in block chain 116 via block chain interface 110 separated from actual video data. In this manner, a third party with rights could search the block chain 116 for specific transactions. For example, the third party could interface with a natural language interface to query: “is there any video recorded on Jan. 6, between 1 and 2 pm near the intersection of Broadway and Fourth Street.” The block chain 116 could then return one or more UIDs, which would in turn refer to actual video stored in repository 114, 97 (FIG. 6) which could be purchased, or otherwise obtained. Block chain 116 could store any type of image information extracted from the captured image data, e.g., time of day/parking availability information; red-lights encountered, traffic flow, etc.

In addition, image processing system 106 may compress the collected image data, e.g., using MPEG-4, to reduce the bandwidth for transmission to the repository 114.

Note that some or all of the processing shown in FIG. 7 could be done remotely after the image data is off-loaded to repository 114, e.g., at image correlation platform 90.

It is understood that the various described embodiments and systems may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A typical computing system may comprise any type of computing device and for example includes at least one processor, memory, an input/output (I/O) (e.g., one or more I/O interfaces and/or devices), and a communications pathway. In general, processor(s) execute program code which is at least partially fixed in memory. While executing program code, processor(s) can process data, which can result in reading and/or writing transformed data from/to memory and/or I/O for further processing. The pathway provides a communications link between each of the components in computing system. I/O can comprise one or more human I/O devices, which enable a user to interact with computing system 10. Computing systems may also be implemented in a distributed manner such that different components reside in different physical locations.

Furthermore, it is understood that components (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system, comprising:
a memory; and
a processor coupled to the memory and configured to implement a drone deployment interface that provides a process for:
rendering a map display of an area over which drones are to be deployed;
overlaying the map display with user defined zones;
assigning drone icons to the user defined zones; and
interfacing with a drone manager to deploy drones to geographic regions corresponding to the user defined zones on which a drone icon was assigned.

2. The system of claim 1, wherein the user defined zones are overlaid onto the map display by drawing on a touch screen.

3. The system of claim 1, wherein the user defined zones are overlaid onto the map display using an editing tool.

4. The system of claim 1, wherein the user defined zones comprise sections of a parking lot.

5. The system of claim 4, further comprising displaying image data of the parking lot.

6. The system of claim 5, wherein the image data depicts sub-zones within a user defined zone of empty, partially filled, or full parking areas.

7. The system of claim 4, further comprising displaying traffic flow information in the parking lot.

8. The system of claim 4, further comprising a system that provides navigation information to vehicles to locate available parking areas.

9. A method for implementing a drone deployment interface, comprising:
rendering a map display of an area over which drones are to be deployed;
overlaying the map display with user defined zones;
assigning drones to selected user defined zones; and
interfacing with a drone manager to deploy drones to capture image data from geographic regions corresponding to selected user defined zones.

10. The method of claim 9, wherein the user defined zones are overlaid onto the map display by drawing on a touch screen.

11. The method of claim 9, wherein the user defined zones are overlaid onto the map display using an editing tool.

12. The method of claim 9, wherein the user defined zones comprise sections of a parking lot.

13. The method of claim 12, further comprising displaying image data of the parking lot.

14. The method of claim 13, wherein the image data depicts sub-zones within a user defined zone of empty, partially filled, or full parking areas.

15. The method of claim 12, further comprising displaying traffic flow information in the parking lot.

16. The method of claim 12, further comprising providing navigation information to vehicles to locate available parking areas.

17. A program product stored on a non-transitory computer readable storage medium, which when executed by a computing system, comprises:
program code for rendering a map display of an area over which drones are to be deployed;
program code for overlaying the map display with user defined zones;
program code for assigning drones to selected user defined zones;
program code for interfacing with a drone manager to deploy drones to capture image data from geographic regions corresponding to selected user defined zones; and
program code for providing navigation information to autonomous vehicles to locate available parking areas in user defined zones.

18. The program product of claim 17, wherein the user defined zones comprise sections of a parking lot.

19. The program product of claim 18, further comprising program code for displaying image data of the parking lot, wherein the image data depicts sub-zones within a user defined zone of empty, partially filled, or full parking areas.

20. The program product of claim 16, further comprising program code for displaying traffic flow information in the parking lot.
